(19) United States
(12) Patent Application Publication
(10) Pub. No.: US 2019/0015290 A1
(43) Pub. Date: Jan. 17, 2019

(54) MASSAGE MACHINE

(71) Applicant: DAITO ELECTRIC MACHINE INDUSTRY COMPANY LIMITED, Higashi-Osaka-shi, Osaka (JP)

(72) Inventors: Yasushi SONE, Higashi-Osaka-shi, Osaka (JP); Xiao Bin FENG, Higashi-Osaka-shi, Osaka (JP); Shinsaku SHIMIZU, Higashi-Osaka-shi, Osaka (JP)

(73) Assignee: DAITO ELECTRIC MACHINE INDUSTRY COMPANY LIMITED, Higashi-Osaka-shi, Osaka (JP)

(21) Appl. No.: 15/577,116

(22) PCT Filed: Jan. 16, 2017
(86) PCT No.: PCT/JP2017/001222

§ 371 Date: Nov. 27, 2017

(30) Foreign Application Priority Data
Dec. 15, 2016 (JP) 2016-243508

(51) Int. Cl. A61H 15/00

(52) U.S. Cl. CPC A61H 15/0078; A61H 2201/0149; A61H 2201/1623; A61H 2205/081; A61H 2201/1654; A61H 2201/1669; A61H 2201/1645

(57) ABSTRACT

In a massage machine including a backrest part, even when a user lays his/her body on the backrest part, a kneading treatment tip does not touch the body of the user, and even when sitting only for reclining use, the user is provided with an excellent feeling of sitting. The massage machine includes a backrest part; a back part massage mechanism disposed inside the backrest part; and first guide rails that are disposed inside the backrest part and vertically guide the back part massage mechanism, the first guide rails are disposed so as to face in a vertical direction, and on the upper end sides of the first guide rails, draw-in parts adapted to draw in the back part massage mechanism backward are formed.

### TECHNICAL FIELD

The present invention relates to a massage machine capable of drawing kneading treatment tips inside a backrest part.

### BACKGROUND ART

As a massage machine adapted to provide guiding means such as guide rails inside a backrest part and enable the guide rails or the like to guide a back part massage mechanism in a vertical direction, there has been conventionally known one as disclosed in Patent Literature 1.

The massage machine of Patent Literature 1 is one adapted to provide guide rails in a backrest part, seat part, and footrest part of the massage machine of a chair type and enable massage parts (massage mechanisms) to move along the guide rails.

### CITATION LIST

### Patent Literatures

### [Patent Literature 1]

Japanese Unexamined Patent Publication JPA2015-80483 (FIG. 3)

### SUMMARY OF INVENTION

### Technical Problem

Meanwhile, the guide rails provided in the massage machine of Patent Literature 1 are provided so as to almost linearly extend along a vertical direction inside the backrest part, and the massage mechanism is made movable in the vertical direction along the guide rails.

When finishing massage by such a massage machine of Patent Literature 1, the massage mechanism moves to the uppermost ends of the guide rails and then comes into a stop state (the upper ends of the guide rails serve as the home position).

However, when using the massage machine as a sofa or a reclining chair with the massage mechanism located in the home position, kneading treatment tips protruding forward from the massage mechanism touch the head of or the back of the neck of a user and often become obstructive. In particular, in many cases, the kneading treatment tips protrude forward from the front surface of the backrest part by an amount nearly equal to one times the thickness of the treatment tips so as to be touchable with a treatment area, and the protruding kneading treatment tips touch a seated user, which is highly likely to interfere with providing a comfortable feeling of sitting.

The present invention is made in consideration of the above-described problem, and intends to provide a massage machine that even when a user lays his/her body on a backrest part, prevents kneading treatment tips from touching the body of the user, and even when the user sits for use as a chair, can provide an excellent feeling of sitting to the user.

### Solution to Problem

In order to solve the above-described problem, the massage machine of the present invention takes the following technical means.

That is, the massage machine of the present invention is a massage machine including: a backrest part; a back part massage mechanism disposed inside the backrest part; and a first guide rail that is disposed inside the backrest part and vertically guides the back part massage mechanism, the first guide rail is disposed so as to face in a vertical direction, and on the upper end side of the first guide rail, a draw-in part adapted to draw in the back part massage mechanism backward is formed.

In addition, it is preferable that the draw-in part is formed by curving backward and extending the upper end side of the first guide rail.

Also, it is preferable that the first guide rail corresponding to the draw-in part is extended in a direction intersecting with the first guide rail located on the lower side than the draw-in part.

Further, it is preferable that the back part massage mechanism includes a kneading treatment tip adapted to perform kneading treatment on a treatment area of a user, and a vertical movement gear adapted to engage with the first guide rail, and the kneading treatment tip is provided on the further front side of the vertical movement gear disposed in the back part massage mechanism.

Still further, it is preferable that a second guide rail extending in the vertical direction is disposed, and the back part massage mechanism is configured to be guided by two mechanisms, i.e., the vertical movement gear adapted to vertically move along the first guide rail and a guide body adapted to vertically move along the second guide rail.

Yet further, it is preferable that the draw-in part is adapted to be capable of drawing in the back part massage mechanism backward by an amount equal to the thickness of the kneading treatment tip.

### Advantageous Effects of Invention

According to the chair type massage machine of the present invention, even when a user lays his/her body on a backrest part, a kneading treatment tip does not touch the body of the user, and even when sitting for use as a chair, the user can be provided with an excellent feeling of sitting.

### BRIEF DESCRIPTION OF DRAWINGS

FIG. 1 is a perspective view of a massage machine of the present embodiment.

FIG. 2 is a perspective view illustrating the internal structure of the massage machine.

FIG. 3 is a perspective view of a back part massage mechanism in a drawn-in state.

FIG. 4 is a perspective view of the back part massage mechanism in a drawn-out state.

FIG. 5 is a cross-sectional view in the case where the back part massage mechanism in the drawn-in state is cut along the vertical direction.

FIG. 6 is a cross-sectional view in the case where the back part massage mechanism in the drawn-out state is cut along the vertical direction.

### DESCRIPTION OF EMBODIMENTS

In the following, a massage machine 1 of the present invention will be described on the basis of the drawings.

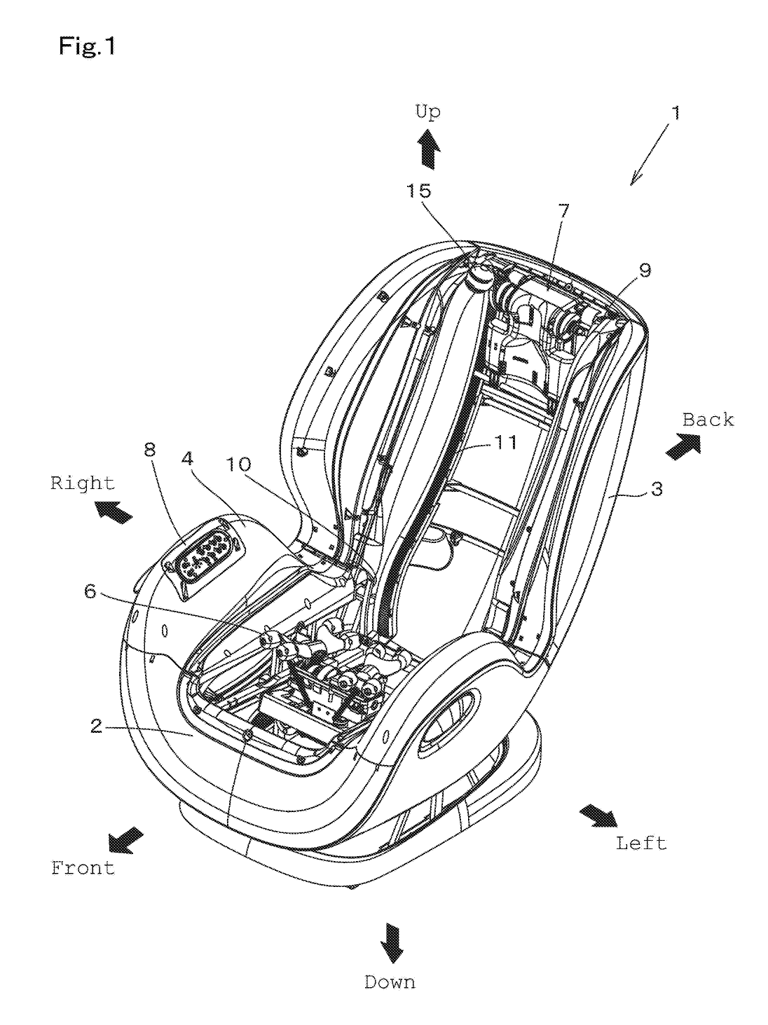

As illustrated in FIG. 1, the massage machine 1 of a first embodiment is configured as a chair-type massage machine having a chair-shaped appearance allowing a user to sit. The massage machine 1 of the first embodiment includes: a seat part 2 on which the user sits; a backrest part 3 on which the user sitting on the seat part 2 reclines; and armrest parts 4 that support both elbows of the user sitting on the seat part 2.

Note that the present embodiment takes as an example the chair-type massage machine including the seat part 2 and the armrest parts 4; however, the massage machine 1 of the present invention is one also applicable to a massage machine (such as a seat-type massage machine) not including a seat part 2 or the armrest parts 4 but including only a backrest part 3.

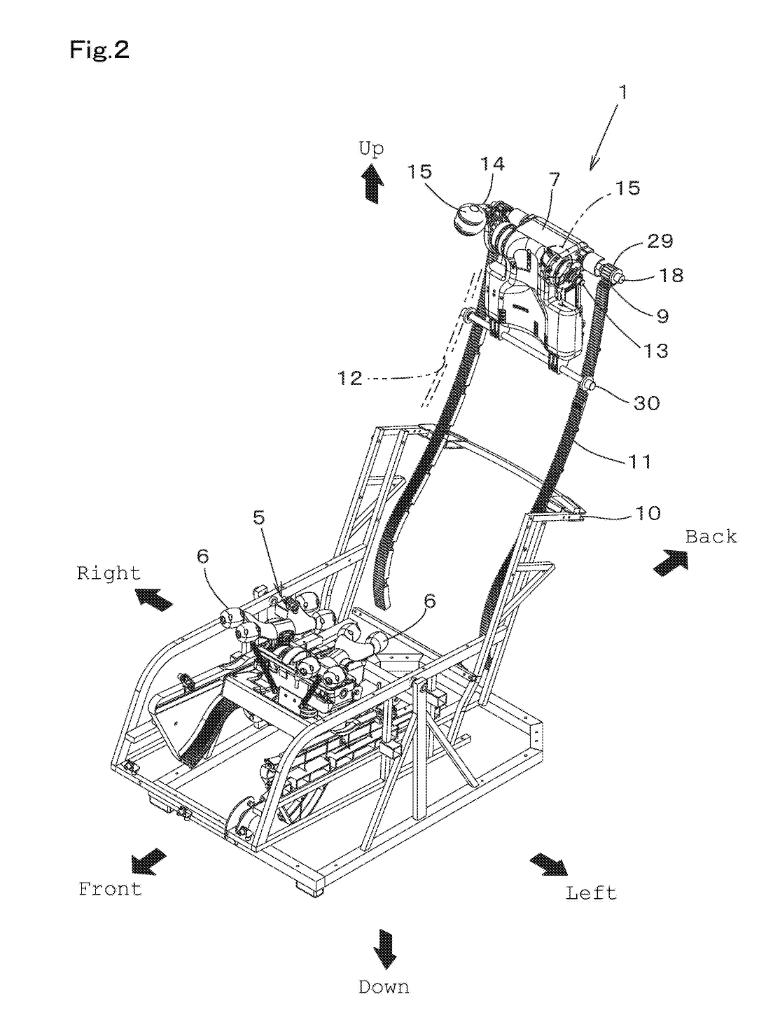

In the following description, a front-back direction, a left-right direction, and an up-down direction indicated by arrows in FIG. 1 and FIG. 2 are respectively defined as a longitudinal direction, a lateral direction, and a vertical direction when the massage machine 1 is described. This agrees in directions as viewed from the user sitting on the massage machine 1. In addition, these directions are appropriately indicated in FIG. 1 and FIG. 2 using the arrows.

The seat part 2 is a part formed flat such that the user can sit, and disposed in the center of the massage machine 1. Note that in FIG. 1, the central flat part is omitted to make the inside viewable; however, the center of the actual massage machine 1 has the flat part, and on the flat part, the user can sit.

Inside the seat part 2, a seat part massage mechanism 5 is provided, and the seat part massage mechanism 5 is configured to give a kneading massage, tapping massage, gripping massage, vibration massage, and the like to a treatment area (a treatment area of the buttocks or femurs) of the user sitting on the seat part 2 using seat part treatment tips 6 protruding upward.

The seat part massage mechanism 5 in the illustrated example is one including a front and back set of four seat part treatment tips 6 (massage balls) arrayed laterally, i.e., eight in total. Also, the seat part massage mechanism 5 is made movable in the longitudinal direction by guide means disposed inside the seat part 2 along the longitudinal direction.

The armrest parts 4 are parts on which the left and right elbows of the user sitting on the seat part 2 can be placed, and respectively provided on the left end side and right end side of the seat part 2. The armrest parts 4 are formed in a shape rising upward of the seat part 2, in other words, in a shape swelling upward in an arc-like manner, and adapted such that the elbows can be placed on the upper ends rising upward. Any of the left and right armrest parts 4 (in the illustrated example, the right armrest part 4) is provided with a control part (a controller) that outputs an operation signal for a massage action or the like to the above-described seat part massage mechanism 5 or the below-described back part massage mechanism 7.

Next, the backrest part 3 will be described.

As illustrated in FIG. 1, the backrest part 3 is a member provided at the back of the seat part 2 so as to rise in the vertical direction, and formed in a vertically long shape so as to be able to support the back of the user sitting on the seat part 2. Specifically, the backrest part 3 is a member that is provided tilted from the vicinity of the back end of the seat part 2 toward the upper back side, and fixed in a state of holding the tilted state with respect to the seat part 2.

Inside the backrest part 3, a support frame 10 formed by combining metallic pipe members or another means is provided, and is adapted to be able to support the weight of the user loaded on the backrest part 3 and the weight of the machine. Also, on the front side of the backrest part 3, a cushioning member such as urethane foam is disposed so as to be able to provide a comfortable feeling of seat to the user. Note that although omitted in FIG. 1, internal structures provided in the backrest part 3, such as the support frame 10 and the cushioning member, are covered with a cover, and the internal structures of the backrest part 3 are provided in non-viewable locations inside the cover.

As illustrated in FIG. 2, inside the backrest part 3, the back part massage mechanism 7 adapted to give a massage to the treatment area of the back of the user reclining on the backrest part 3, and first guide rails 11 capable of guiding the back part massage mechanism 7 in the tilt direction (the lower front side to upper back side) of the backrest part 3 are provided. Note that as indicated by virtual lines, on the front sides of the first guide rails 11, second guide rails 12 adapted to guide the back part massage mechanism 7 in the vertical direction as with the first guide rails 11 are also provided. That is, the back part massage mechanism 7 is adapted to be guidable in the vertical direction by the two sets of guide rails, i.e., the first guide rails 11 and the second guide rails 12.

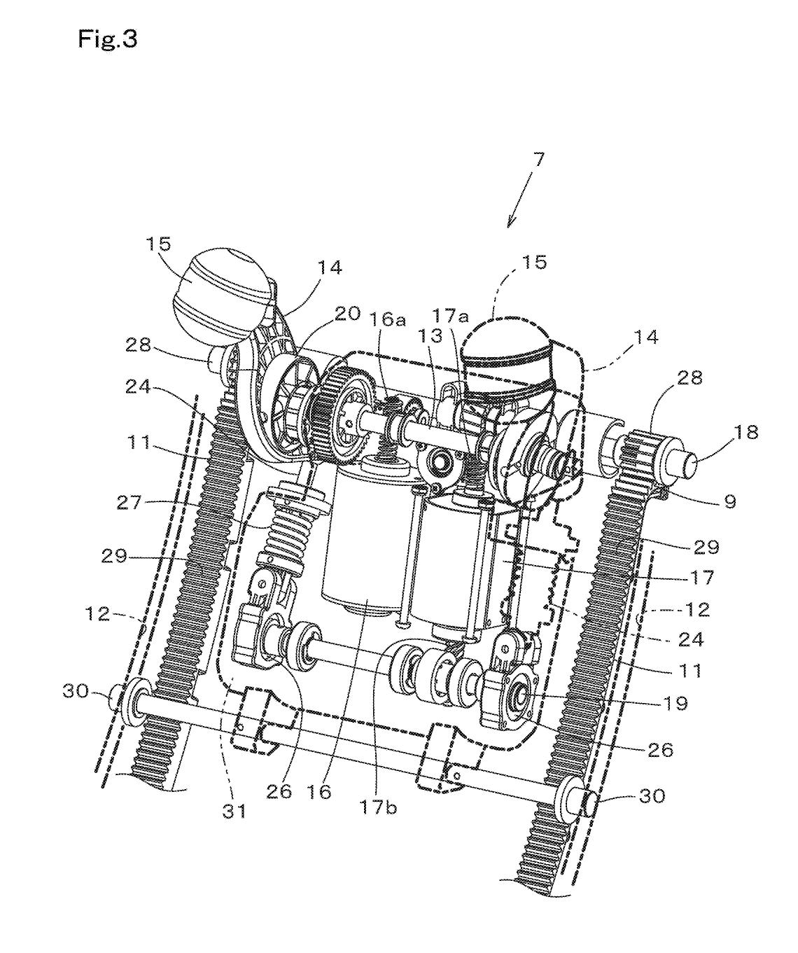

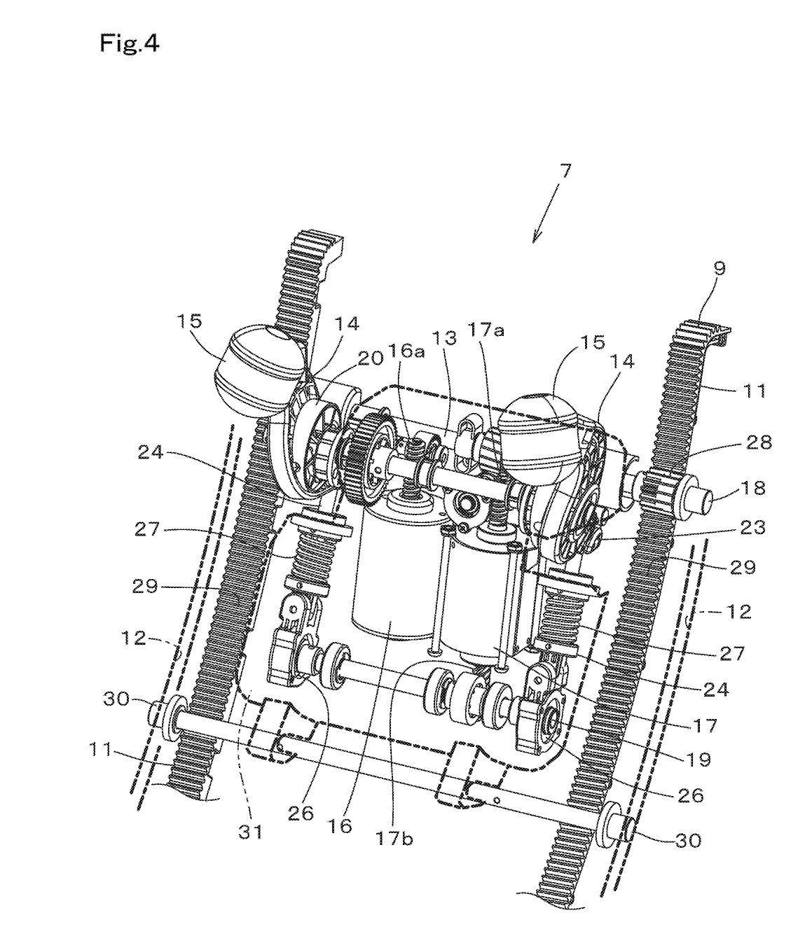

As illustrated in FIG. 3 and FIG. 4, the back part massage mechanism 7 includes, on a base body 31 formed in a substantially rectangular shape: long kneading arm members 14 protruding forward and slightly upward from base end sides connected to the below-described kneading rotary shaft 13; and kneading treatment tips 15 provided on the fore end sides of the kneading arm members 14 to give a kneading massage to the treatment area of the back of the user. The kneading treatment tips 15 and the kneading arm members 14 are provided as left and right pairs, and adapted to be movable using the rotational driving force of the below-described motor (first motor 16).

The back part massage mechanism 7 is provided with two motors on the base body 31, i.e., the first motor 16 and a second motor 17. The first and second motors 16, 17 are disposed with the shaft centers of driving shafts facing in the vertical direction, and provided arranged mutually laterally. The first motor 16 is a motor disposed on the right side between the two motors, and generates the driving force (the rotational driving force) for the kneading massage of the treatment area. Also, the second motor 17 is a motor disposed on the left side, and generates a driving force (a vertical movement driving force) for moving the back part massage mechanism 7 in the vertical direction (vertically moving) and a driving force for the tapping massage of the treatment area.

The first motor 16 is attached so as to extend the driving shaft 16a upward. The rotational driving force of the driving shaft 16a of the first motor 16 is transmitted to the kneading rotary shaft 13 through a power transmitting mechanism configured to include a worm gear and a worm wheel. In this manner, the rotational driving force generated by the first motor 16 is adapted to be transmitted to the kneading rotary shaft 13 in a decelerated state, and the kneading rotary shaft 13 is adapted to be rotationally driven around an axis facing in the lateral direction.

As with the first motor 16, the second motor 17 is a motor attached such that the shaft center of the driving shaft faces in the vertical direction. Differently from the first motor 16, the second motor 17 is configured as a double-shaft motor whose driving shafts 17a and 17b extend upward and downward respectively.

The rotational driving force of the upper driving shaft 17a of the second motor 17 is transmitted through a power transmitting mechanism configured to include a worm gear and a worm wheel to a vertical movement rotary shaft 18 whose shaft center faces in the lateral direction. In this manner, part of the rotational driving force generated by the second motor 17 is adapted to be transmitted to the vertical movement rotary shaft 18 in a decelerated state, and the vertical movement rotary shaft 18 is adapted to be rotationally driven around an axis facing in the lateral direction.

On the other hand, the rotational driving force generated through the lower driving shaft 17b of the second motor 17 is also adapted to be transmitted to a tapping rotary shaft 19 through a power transmission mechanism configured to include a worm gear and a worm wheel, and the tapping rotary shaft 19 is adapted to be rotationally driven around a shaft facing in the lateral direction.

Next, kneading massage means, tapping massage means, and vertical movement means activated using the rotational driving forces transmitted to the above-described kneading rotary shaft 13, vertical movement rotary shaft 18, and tapping rotary shaft 19 will be described.

The kneading massage means has a pair of left and right tilted bosses 20 provided on the left end side and right end side of the kneading rotary shaft 13. The pair of left and right tilted boss parts 20 are cylindrically-shaped members provided such that the shaft centers face in the lateral direction, and on the outer circumferential surfaces, tilted cam surfaces that are tilted in the lateral direction and laid around the shaft centers are formed. The respective tilted cam surfaces are formed so as to have tilt directions opposite to (directly opposite to) each other in the left and right tilted boss parts 20. For example, in the case where the left tilted cam surface is downward to the left, the right tilted cam surface is downward to the right, and in the case where the left is upward to the left, the right tilted cam surface is upward to the right. The base end sides of the kneading arm members 14 are fitted to the respective tilted cam surfaces from outside via annular-shaped bearing members so as to be rotationally movable around the shaft centers tilted in the lateral direction.

On the other hand, on the back end surfaces of the kneading arm members 14 on the base end sides, boot parts 23 are formed. The boot parts 23 are members that rotationally movably support ball joint parts of the below described connecting shaft members 24, and adapted to be connectable to the ball joint parts swingably longitudinally and laterally, and the boot parts 23 and the ball joint parts constitute connecting structures of a ball joint type. That is, the connecting structures of the ball joint type restrict the kneading arm members 14 from rotationally moving integrally with the tilted boss parts 20.

Accordingly, even when rotationally driving the above-described kneading rotary shaft 13, since the kneading arm members 14 are restricted from rotationally moving integrally with the tilted boss parts 20, the kneading arm members 14 slide on the tilted cam surfaces, but does not rotationally move integrally with the tilted boss parts 20. On the other hand, even when the kneading arm members 14 are restricted from the integral rotational movement, the kneading arm members 14 are allowed to swing in the lateral direction. For this reason, the kneading arm members 14 to which the rotational driving force through the kneading rotary shaft 13 is transmitted consequently repeatedly swing in the lateral direction.

Also, since the above-described tilted cam surfaces are opposite in tilt direction between the left tilted boss part 20 and the right tilted boss part 20, the left and right arm members 14, 14 mutually alternately repeat an approaching action and a separating action, and the kneading massage can be given to the treatment area located between the kneading treatment tips 15 repeating the approaching/separating.

On the other hand, the tapping massage means includes: the tapping rotary shaft 19 disposed with the shaft center facing in the lateral direction; and eccentric boss parts 26 provided on the tapping rotary shaft 19. The eccentric boss parts 26 are members formed in a disc-like shape around an axis facing in the lateral direction, and the eccentric boss members 26 are attached eccentrically to the shaft center of the tapping rotary axis 19. In addition, the eccentric boss parts 26 and the base end sides of the above-described kneading arm members 14 are connected using the connecting shaft members 24. For this reason, when rotationally driving the tapping rotary shaft 19, the base end sides of the kneading arm member 14 move in the vertical direction with a short period, and the kneading treatment tips 15 provided at the fore end of the kneading arm members 14 can be repeatedly reciprocated in the vertical direction or in the longitudinal direction with a short period, thus making it possible to give the tapping massage that taps the treatment area with the kneading treatment tips 15.

In addition, in the middle of the connecting shaft members 24 in the vertical direction, spring members 27 that connect between the eccentric boss parts 26 and the kneading arm members 14 while allowing the connecting shaft members 24 to elongate and contract along the vertical direction are provided. Providing such spring members 27 makes it possible to reduce the impact of the kneading treatment tips 15 on the treatment area at the time of the tapping massage.

The above-described vertical movement means is one adapted to move the back part massage mechanism 7 in the vertical direction, and includes: a vertical movement rotary shaft 18 disposed on the backside of the kneading rotary shaft 13 with the shaft center facing in the lateral direction; and vertical movement gears 28 disposed at both ends of the vertical movement rotary shaft 18. The vertical movement gears 28 are attached so as to engage with the first guide rails 11 formed in the backrest part 3.

Specifically, the rotational driving force generated by the second motor 17 is transmitted to the middle of the vertical movement rotary shaft 18 in the lateral direction through the above-described power transmitting mechanism having the worm gear, and the vertical movement rotary shaft 18 is rotationally driven around the shaft center facing in the lateral direction. At both of the left and right ends of the vertical movement rotary shaft 18, the vertical movement gears 28 are respectively provided.

The left and right first guide rails 11 are members disposed vertically tilted along the tilt direction of the backrest part 3. On the surfaces (front surfaces) of the respective first guide rails 11, gear teeth 29 adapted to engage with the above-described vertical movement gears 28 are formed facing forward, and engaging the vertical movement gears 28 with the gear teeth 29 of the first guide rails 11 allows the back part massage mechanism 7 to be moved in the vertical direction along the first guide rails 11 (to be traveled in the vertical direction on the first guide rails 11).

Also, on the front sides of the first guide rails 11, the second guide rails 12 laid along the vertical direction as with the first guide rails 11 are provided. The second guide rails 12 are groove-shaped rails (sliding rails) not provided with any gear tooth 29, differently from the first rails 11, and adapted to be able to vertically guide a guide body 30 of the back part massage mechanism 7 in a sliding state. Specifically, the guide body 30 is a cylindrically-shaped member protruding outward in a width direction from left and right side surfaces of the back part massage mechanism 7 on the lower end side (protruding leftward from the left side surface of the back part massage mechanism 7, as well as protruding rightward from the right side surface). In addition, the second guide rails 12 have grooves insertable with the guide body 30 so as to open the grooves inward in the width direction, and the grooves are formed along the laying direction of the second guide rails 12. Accordingly, when the back part massage mechanism 7 moves in the vertical direction with the vertical movement gears 28 engaging with the gear teeth 29 of the first guide rails 11, the guide body 30 of the back part massage mechanism 7 also moves in the vertical direction along the second guide rails 12, and the back part massage mechanism 7 is guided by two mechanism, i.e., the vertical movement gears 28 and the guide body 30. In detail, it is configured to provide the vertical movement gears 28 on the upper end side on the base body, and provide the guide body 30 on the lower end side.

Meanwhile, the massage machine 1 of the present invention is characterized by, on the upper end sides of the first guide rails 11, including draw-in parts 9 adapted to draw in the back part massage mechanism 7 backward.

The draw-in parts 9 are ones formed by curving backward and extending the upper end sides of the first guide rails 11. That is, the first guide rails 11 corresponding to the draw-in parts 9 are ones extended in a direction (in the horizontal direction) intersecting with the first guide rails 11 located on the lower sides than the draw-in parts 9.

Next, the draw-in parts 9 characterizing the present invention will be described in detail.

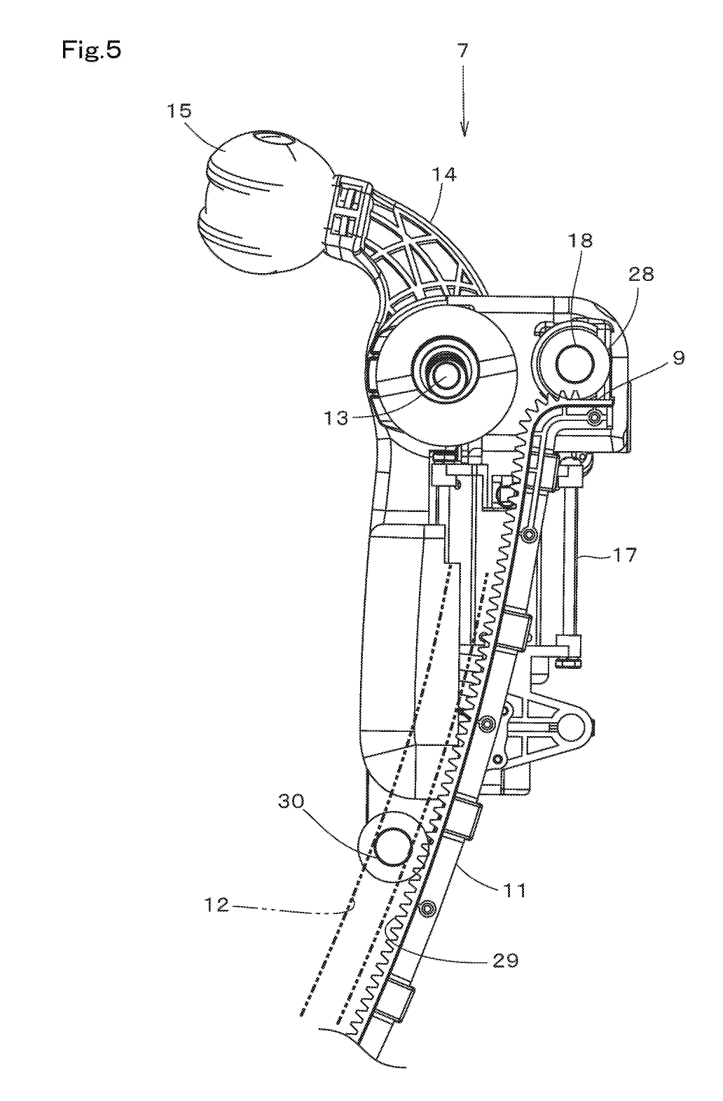

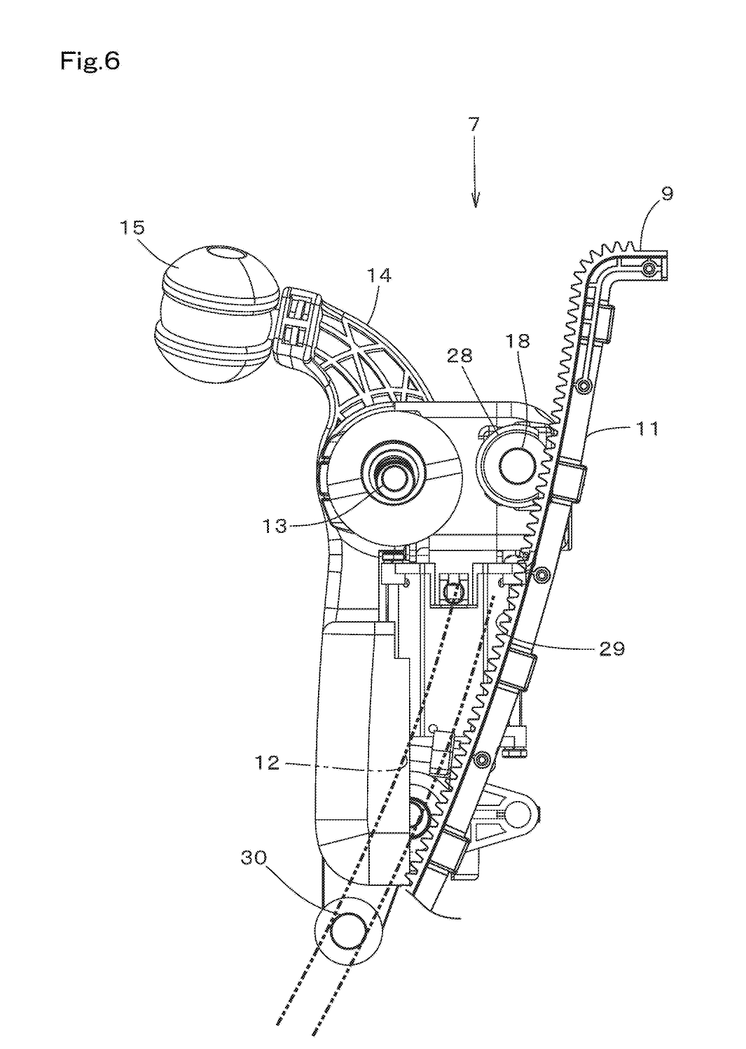

As illustrated in FIG. 5 and FIG. 6, the draw-in parts 9 are parts formed by curving the upper end sides of the first guide rails 11 backward in an almost orthogonal direction. The direction in which the draw-in parts 9 are curved is one along the longitudinal direction, and substantially orthogonal to the first guide rails 11 on the lower sides than the draw-in parts 9, which are ones almost along the vertical direction.

Further, on the upper sides of the first guide rails 11 of the draw-in parts 9, the above-described gear teeth are formed as well. In addition, the curved portions of the draw-in parts 9 are formed to have a somewhat large curvature radius such that the vertical movement gears 28 can smoothly pass through the curved portions. Note that specifically, the first guide rails 11 on the lower sides of the draw-in parts 9 and the first guide rails 11 of the draw-in parts 9 preferably intersect with each other at an angle of 60° to 120°.

Further, in the case where the longitudinal thickness of the kneading treatment tips 15 is assumed as a reference, the length of the draw-in parts 9 along the longitudinal direction (the length of the extensions to the back) is set to 0.5 times to 1 times. In doing so, the kneading treatment tips 15 can be drawn in backward by an amount nearly equal to 0.5 times to 1 times the thickness, and the forward protruding amount of the kneading treatment tips 15 can be decreased by the drawn-in amount.

That is, by providing the above-described draw-in parts 9 on the upper end sides of the first guide rails 11, the vertical movement gears 28 can be drawn in backward, and the attitude of the back part massage mechanism 7 in the home position is an reclining one, so that the forward protruding amount of the kneading treatment tips 15 can be kept small. For this reason, even when the user lays his/her body on the backrest part 3, the kneading treatment tips 15 do not touch the body of the user, and even when sitting on the massage machine 1 for use as a chair, the user can be provided with an excellent feeling of sitting.

Note that the tilting action of the back part massage mechanism 7 made performable by providing the draw-in parts 9 is one that is to be performed with the lower end of the back part massage mechanism 7, at which the above-described guide body 30 is provided, as a swing center, and is one such that the upper end side of the back part massage mechanism 7 reclines with the lower end as the center. For this reason, in order to prevent the upper end side of the back part massage mechanism 7 from interfering with the first guide rails 11 or the second guide rails 12, it is preferable to make the lateral width of the back part massage mechanism 7 (the width of the base body 31) narrower than the lateral distances between the first guide rails 11 and between the second guide rails 12.

Also, since the back part massage mechanism 7 is one adapted to swing the upper end provided with the kneading treatment tips 15 in the longitudinal direction with the lower end as the center, in order to make it possible to largely draw in the kneading treatment tips 15 backward, it is preferable to provide the kneading treatment tips 15 on the upper end side of the back part massage mechanism 7 separated from the lower end as the swing center, specifically to provide the kneading treatment tips 15 on the front sides (forward and obliquely upward) of the vertical movement gears 28.

In other words, when drawing in the kneading treatment tips 15 backward in the above-described massage machine 1, it is preferable to perform the following operation.

That is, FIG. 6 illustrates a cross-sectional view of the massage machine 1 in which the positions of the vertical movement gears 28 are on the lower sides than the draw-in parts 9. As illustrated in FIG. 6, the vertical movement gears 28 in upward movement upward from below along the first guide rails 11 on the lower sides of the draw-in parts 9 cause the kneading treatment tips 15 to protrude forward and upward.

However, as illustrated in FIG. 5, after passing through the curved portions, the vertical movement gears 28 travel backward on the first guide rails 11 of the draw-in parts 9 facing in the horizontal direction, and the position of the back part massage mechanism 7 on the upper end side provided with the vertical movement gears 28 also changes backward. As a result, the upper end side of the back part massage mechanism 7 shifts forward with the lower end side located on the second guide rails 12 as the center, the attitude of the back part massage mechanism 7 changes from one rising along the vertical direction to a reclining one, and along with the change in the attitude, the positions of the kneading treatment tips 15 move backward by an amount nearly equal to 0.5 times to 1 times the thickness to prevent the kneading treatment tips 15 from significantly protruding forward.

Therefore, even when the user lays his/her body on the backrest part 3, the kneading treatment tips 15 protruding forward too much do not touch the body of the user, and even when sitting for only reclining use as a chair, the user can be provided with an excellent feeling of sitting.

Note that it should be considered that the embodiment disclosed this time is illustrative in all aspects but not a limited one. In particular, in the embodiment disclosed this time, matters not explicitly disclosed, such as driving conditions, operating conditions, various parameters, and the dimensions, weights, and volumes of components are not ones departing from the scope of ordinary implementation by a person skilled in the art, but employ values that an ordinary person skilled in the art can easily assume.

### REFERENCE SIGNS LIST

1 Massage machine
2 Seat part
3 Backrest part
4 Armrest part
5 Seat part massage mechanism
6 Seat part treatment tip
7 Back part massage mechanism
8 Control part (controller)
9 Draw-in part
10 Support frame
11 First guide rail
12 Second guide rail
13 Kneading rotary shaft
14 Kneading arm member
15 Kneading treatment tip
16 First motor
16a Driving shaft of first motor
17 Second motor
17a Upper driving shaft of second motor
17b Lower driving shaft of second motor
18 Vertical movement rotary shaft
19 Tapping rotary shaft
20 Tilted boss part
23 Boot part
24 Connecting shaft member
26 Eccentric boss part
27 Spring member
28 Vertical movement gear
29 Gear tooth
30 Guide body
31 Base body

1. A massage machine comprising:
a backrest part;
a back part massage mechanism disposed inside the backrest part; and
a first guide rail that is disposed inside the backrest part and vertically guides the back part massage mechanism, wherein
the first guide rail is disposed so as to face in a vertical direction, and on an upper end side of the first guide rail, a draw-in part adapted to draw in the back part massage mechanism backward is formed.

2. The massage machine according to claim 1, wherein
the draw-in part is formed by curving backward and extending the upper end side of the first guide rail.

3. The massage machine according to claim 2, wherein
the first guide rail corresponding to the draw-in part is extended in a direction intersecting with the first guide rail located on a lower side than the draw-in part.

4. The massage machine according to claim 3, wherein
the back part massage mechanism comprises a kneading treatment tip adapted to perform kneading treatment on a treatment area of a user, and a vertical movement gear adapted to engage with the first guide rail, and
the kneading treatment tip is provided on a further front side of the vertical movement gear disposed in the back part massage mechanism.

5. The massage machine according to claim 4, wherein
a second guide rail extending in the vertical direction is disposed, and
the back part massage mechanism is configured to be guided by two mechanisms.

6. The massage machine according to claim 4, wherein
the draw-in part is adapted to be capable of drawing in the back part massage mechanism backward by an amount equal to thickness of the kneading treatment tip.

7. The massage machine according to claim 5, wherein
the draw-in part is adapted to be capable of drawing in the back part massage mechanism backward by an amount equal to thickness of the kneading treatment tip.

8. The massage machine according to claim 5, wherein
the two mechanisms are the vertical movement gear adapted to vertically move along the first guide rail and a guide body adapted to vertically move along the second guide rail.
